(19) United States
(12) Patent Application Publication
(10) Pub. No.: US 2017/0270124 A1
(43) Pub. Date: Sep. 21, 2017

(54) Data Management Device, Data Management System, and Data Management Method

(71) Applicant: Kabushiki Kaisha Toshiba, Tokyo (JP)

(72) Inventors: Shinichi NAGANO, Yokohama (JP); Mamiko Abe, Tokyo (JP); Eiichi Sunagawa, Tokyo (JP); Mitsunobu Yoshida, Kawasaki (JP)

(21) Appl. No.: 15/267,738

(22) Filed: Sep. 16, 2016

(30) Foreign Application Priority Data
Mar. 17, 2016 (JP) 2016-053603

(51) Int. Cl. G06F 17/30

(52) U.S. Cl. CPC G06F 17/3053; G06F 17/30958; G06F 17/30528; G06F 17/30554

(57) ABSTRACT

A data management device has a knowledge graph data generator to generate knowledge graph data by relating spatial data concerning space within a building in which a maintenance facility is installed, facility data concerning the maintenance facility, and measurement data obtained by measuring an operational status of the maintenance facility in accordance with ontology transformation rules, a search information input unit to input a search keyword including a character string representing an incident, a data search unit to search the knowledge graph data based on the search keyword, and a search result output unit to relate and output the spatial data, facility data, and measurement data matching with the search keyword, based on search results obtained by the data search unit.

### CROSS REFERENCE TO RELATED APPLICATIONS

This application is based upon and claims the benefit of priority from the prior Japanese Patent Application No. 2016-53603, filed on Mar. 17, 2016, the entire contents of which are incorporated herein by reference.

### FIELD

Embodiments relate to a data management device, a data management system, and a data management method.

### BACKGROUND

Markets for monitoring infrastructure facilities all the time by utilizing Information Communication Technology (ICT) have been enlarged due to the increase in old infrastructures, accelerated decrease in working population, etc. Judgment in the field is important to diagnose the failure and abnormality of the facilities, which essentially requires quick decision-making supported by operational data. SCADA (Supervisory Control And Data Acquisition) products have been developed and sold to monitor systems and control processes by computers. Although mobile-ready SCADA products intended for the use in the working field are known, the operability and functions thereof are not good enough at present.

### BRIEF DESCRIPTION OF THE DRAWINGS

FIG. 1 is a block diagram showing a schematic structure of a data management system having a data management device.

FIG. 2 is a diagram explaining spatial data.

FIG. 3 is a diagram showing an example of a data structure of spatial data corresponding to FIG. 2.

FIG. 4 is a diagram showing an example of an installation situation of air conditioners in a building.

FIG. 5 is a diagram showing an example of a data structure of facility data corresponding to FIG. 4.

FIG. 6 is a diagram showing an example of a data structure of measurement data.

FIG. 7 is a diagram showing an example of a data structure of feature data.

FIG. 8 is a diagram showing an example of a data structure of incident data.

FIG. 9 is a diagram showing an example of knowledge graph data (ontology data).

FIG. 10 is a diagram showing with arrows how to generate the knowledge graph data referring to the spatial data, facility data, measurement data, feature data, and incident data.

FIG. 11A is a flow chart showing an example of an operating procedure of a knowledge graph data generator.

FIG. 11B is a flow chart subsequent to FIG. 11A.

FIG. 12 is a flow chart showing an example of an operating procedure of a data search unit.

FIG. 13 is a diagram showing an example of a search query specifying a search keyword for the incident data.

FIG. 14 is a diagram showing an example of a search query specifying a search keyword for the feature data in the measurement data.

FIG. 15 is a diagram showing an example of a search query specifying a search keyword for the spatial data.

FIG. 16 is a diagram showing an example of a search query specifying a search keyword for the facility data.

FIG. 17 is a flow chart showing an example of an operating procedure of a search result output unit.

FIG. 18 is a diagram showing an example of the initial screen of a client terminal issuing a search request.

FIG. 19 is a diagram showing an example of time-series graphs on a display screen when selecting “air conditioning” by a button for selecting an incident.

FIG. 20 is a diagram showing an example of spatial maps on a display screen.

FIG. 21 is a diagram showing an example of system maps on a display screen.

### DETAILED DESCRIPTION

A data management device according to one embodiment has a knowledge graph data generator to generate knowledge graph data by relating spatial data concerning space within a building in which a maintenance facility is installed, facility data concerning the maintenance facility, and measurement data obtained by measuring an operational status of the maintenance facility in accordance with ontology transformation rules, a search information input unit to input a search keyword including a character string representing an incident, a data search unit to search the knowledge graph data based on the search keyword, and a search result output unit to relate and output the spatial data, facility data, and measurement data matching with the search keyword, based on search results obtained by the data search unit.

Hereinafter, embodiments will be explained referring to the drawings. The following explanation will be given mainly on a data management device and a data management method applicable to the purpose of maintenance work for maintenance facilities within a building. The data to be managed by the data management device includes spatial data concerning space in the building in which target maintenance facilities are installed, facility data concerning the maintenance facilities, and measurement data obtained by measuring the operational status of the maintenance facilities.

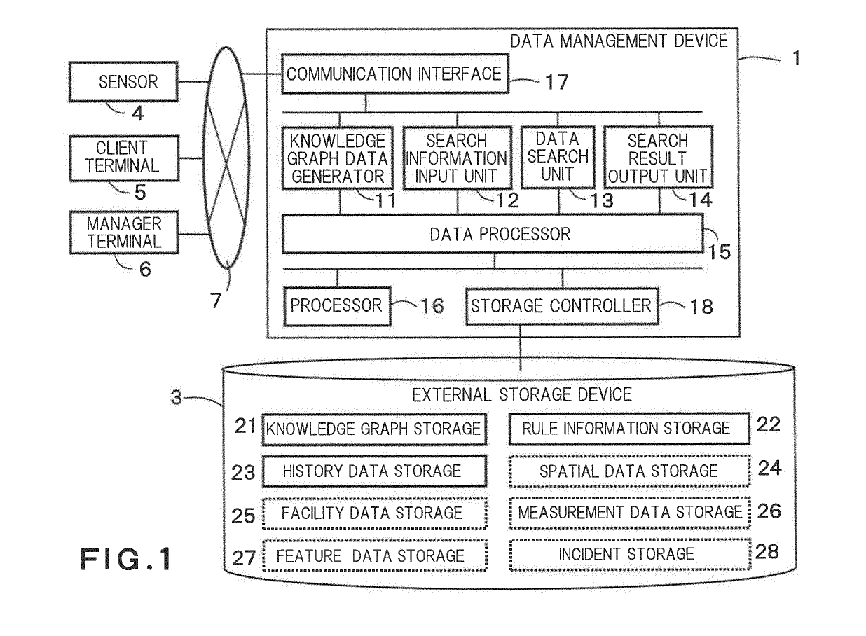

FIG. 1 is a block diagram showing a schematic structure of a data management system 2 having a data management device 1 according to an embodiment. The data management system 2 of FIG. 1 has the data management device 1, an external storage device 3, a sensor 4, a client terminal 5, and a manager terminal 6.

The external storage device 3 may be incorporated in the data management device 1, but in the example to be explained below, the external storage device 3 is provided separately from the data management device 1. The data management device 1 and external storage device 3 may be connected through a dedicated line or through a network 7. For example, the external storage device 3 may be provided in a cloud environment connected to the Internet.

The sensor 4, client terminal 5, and manager terminal 6 are connected to the data management device 1 through the network 7. The client terminal 5 is assumed to be carried with each maintenance worker performing maintenance work on various facilities within the building. Thus, the number of client terminals 5 should not be limited to only one. The client terminal 5 transmits various search requests concerning maintenance work to the data management device 1 through the network 7, and receives search result data depending on the search requests from the data management device 1.

The data management device 1 searches knowledge graph data responding to a search request from the client terminal 5, and outputs search result data. More specifically, the data management device 1 transmits the search result data to the client terminal 5 through the network 7, and the client terminal 5 receives the search result data and displays search results on its display screen. In the present embodiment, explanation will be given on an example where search result information to be displayed on the display screen of the client terminal 5 is generated by the data management device 1.

The sensor 4 is provided to detect the operational status etc. of various facilities within the building, as mentioned later. In the present embodiment, a plurality of types of sensors 4 are installed everywhere within the building. The sensor 4 transmits the measurement data to the data management device 1 through the network 7. The measurement data may be transmitted by using a well-known protocol such as MQTT, Fluentd, and XMPP, or by using a unique delivery procedure implemented in a lightweight protocol such as CoAP and HTTP 2.0.

The manager terminal 6 adds and updates the spatial data, facility data, etc. and transmits the updated spatial data, facility data, etc. to the data management device 1 through the network 7. The manager terminal 6 transmits and receives data utilizing the functions of DBMS (Database Management System), for example. Note that the functions of the manager terminal 6 may be incorporated into the data management device 1.

The data management device 1 has a knowledge graph data generator 11, a search information input unit 12, a data search unit 13, and a search result output unit 14. In addition, the data management device 1 further has a data processor 15, a processor 16, a communication interface 17, and a storage controller 18.

The knowledge graph data generator 11 generates knowledge graph data by relating the spatial data, facility data, and measurement data in accordance with ontology transformation rules. The knowledge graph data is also called ontology data. The knowledge graph data generator 11 may generate the knowledge graph data by relating four types of data including the above three types of data and incident data concerning an incident as an event of concern in maintenance work, in accordance with ontology transformation rules. The knowledge graph data generated is stored in the external storage device 3.

The search information input unit 12 inputs a search keyword including a character string representing an incident. The data search unit 13 searches the knowledge graph data based on the search keyword inputted by the search information input unit 12. More concretely, the data search unit 13 extracts data matching with the search keyword from the knowledge graph data. The data search unit 13 may employ either complete or partial matching of a coupling of string data. The search information input unit 12 may input an output format in the search result output unit 14, as mentioned later. Further, the search information input unit 12 may select a search keyword from a list of character strings determined in advance, instead of inputting the search keyword.

The search result output unit 14 relates and outputs the spatial data, facility data, and measurement data matching with the search keyword, based on the search results obtained by the data search unit 13. When the measurement data includes feature data and the search information input unit 12 inputs a search keyword including a character string representing an incident and a feature data, the search result output unit 14 relates and outputs the spatial data, facility data, and measurement data matching with this search keyword. Here, the feature data represents the features of the measurement data.

Further, when the search information input unit 12 inputs an output format, the search result output unit 14 may generate and output at least one of a time-series graph, a spatial map, and a system map in accordance with that output format, based on the spatial data, facility data, and measurement data matching with the search keyword.

The search result output unit 14 may sort the search results obtained by the data search unit 13 in order of importance level based on evaluation rules, to output the spatial data, facility data, and measurement data matching with the search keyword in order of importance level. Here, the evaluation rules are defined for giving importance levels to the search results obtained by the data search unit 13. An evaluation rule as a concrete example is that data having higher appearance frequency is given a higher importance level. In the case of employing an evaluation rule defining that the facility data is given the highest importance level, the facility data having the highest appearance frequency is outputted at the top.

The data processor 15 performs data processing including transmitting and receiving various data to and from the knowledge graph data generator 11, search information input unit 12, data search unit 13, and search result output unit 14 under the instructions from the processor 16. The storage controller 18 transmits and receives data to and from the external storage device 3 responding to the requests from the processor 16 and data processor 15,

The external storage device 3 has a knowledge graph storage 21 storing the knowledge graph data, a rule information storage 22 storing ontology transformation rules, and a history data storage 23. The rule information storage 22 may store various rules in addition to the ontology transformation rules. For example, the rule information storage 22 may store feature data rules for extracting a feature data included in the measurement data, evaluation rules for performing search by the data search unit 13, and graph generation rules for generating a graph by the search result output unit 14. Here, the graph generation rules are defined for displaying search results on a graph or a map by the search result output unit 14. The history data storage 23 stores history information such as search requests transmitted from the client terminal 5, search results obtained by the data search unit 13, and output (browsing) information about the search result output unit 14.

In addition, the external storage device 3 may have a spatial data storage 24 storing the spatial data, a facility data storage 25 storing the facility data, and a measurement data storage 26 storing the measurement data. The external storage device 3 may further have a feature amount storage 27 storing the feature data and an incident storage 28 storing the incident data.

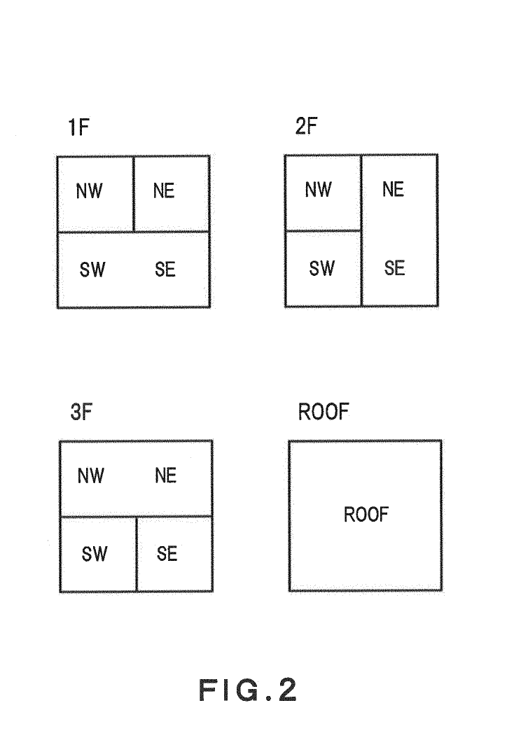

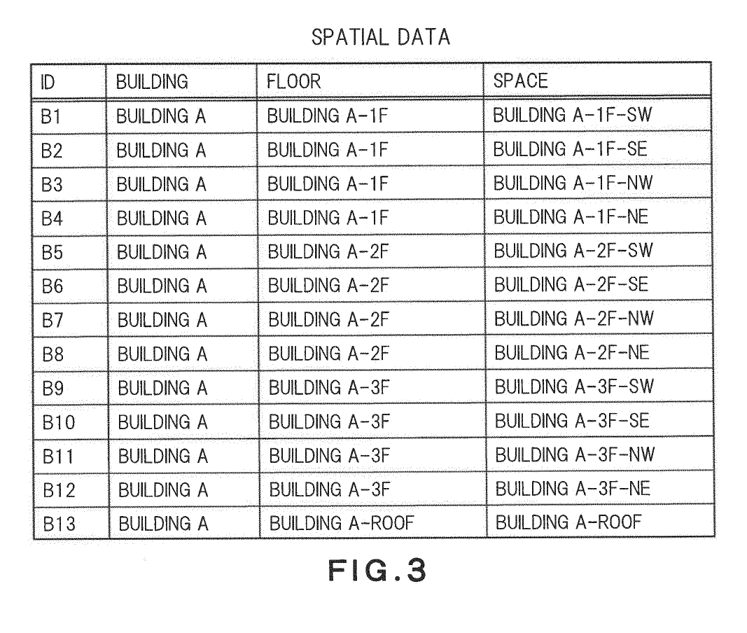

FIG. 2 is a diagram explaining the spatial data, and FIG. 3 is a diagram showing an example of a data structure of the spatial data corresponding to FIG. 2. FIG. 2 shows an example of setting space for each room on every floor including the roof in a three-story office building. The space is divided corresponding to the control zones of air conditioners.

In the example of FIG. 2, for example, the first floor has three rooms, of which two small rooms have separate spaces NW and NE respectively and one large room has two spaces SW and SE, Each of the second floor and third floor similarly has four spaces, and the roof has one space.

As shown in FIG. 3, the spatial data is CSV (Comma-Separated Value) format data obtained by relating ID for identifying the space, identification information about the building, identification information about the floor, and identification information about the space. Note that the data structure and data format of the spatial data should not be limited to the above. For example, a standard data model for expressing the information about building space, such as BIM (Building Information Modeling) and IFC (Industry Foundation Classes), may be employed.

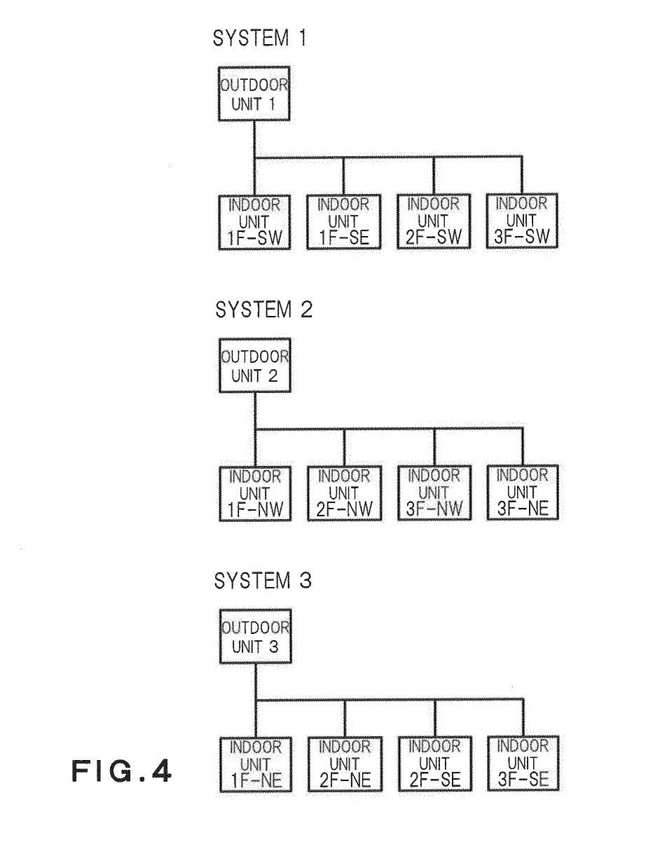

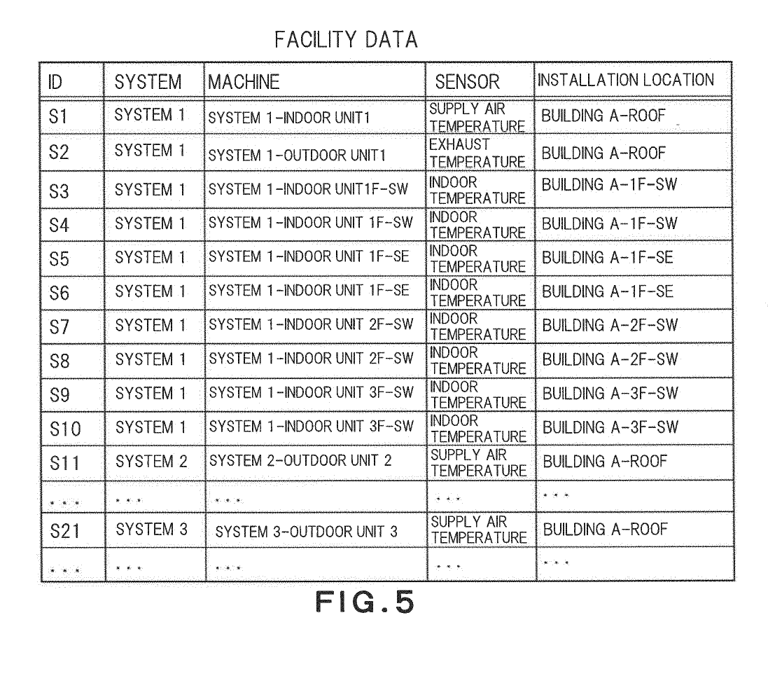

FIG. 4 is a diagram showing an example of an installation situation of air conditioners in the building, and FIG. 5 is a diagram showing an example of a data structure of the facility data corresponding to FIG. 4. FIGS. 4 and 5 are provided assuming multi air conditioners for building.

In the example of FIG. 4, there are three air conditioning systems each having one outdoor unit and three indoor units. Each system is provided on the floor corresponding thereto, for example.

As shown in FIG. 5, the facility data is CSV format data obtained by relating an ID for identifying each outdoor or indoor unit, identification information about a system, the name of each outdoor or indoor unit, the measurement target of the sensor 4 concerned, and the installation location of each outdoor or indoor unit. Note that the data structure and data format of the facility data should not be limited to the above. For example, a standard data model for expressing the information about facility attributes, such as COBie (Construction Operations Building Information Exchange), may be employed.

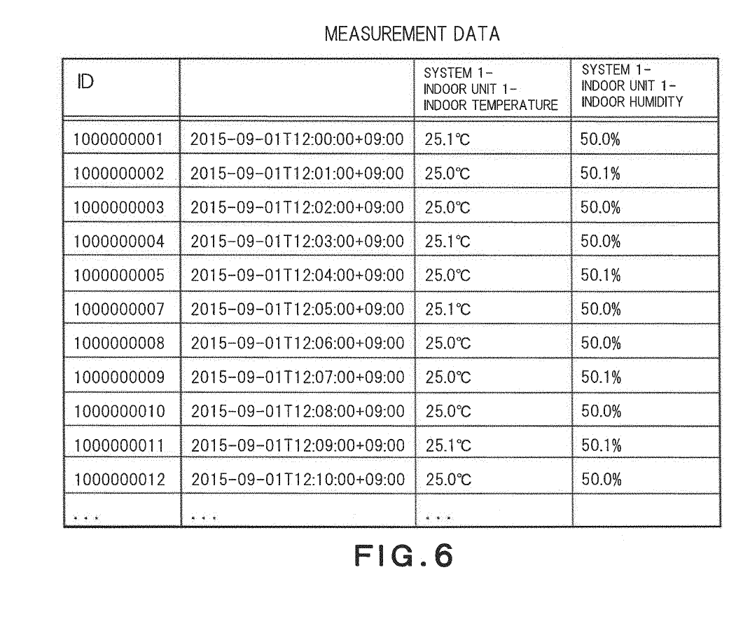

FIG. 6 is a diagram showing an example of a data structure of the measurement data. The measurement data of FIG. 6 shows an example of recording the temperature and humidity of a specific indoor unit installed in a specific space on a specific floor at unit time (e.g. one minute) intervals. More concretely, the measurement data of FIG. 6 is CSV format data obtained by relating the ID of each indoor unit, the date and time of measurement, indoor temperature, and indoor humidity.

Air conditioners are expected to perform optimum air-conditioning control depending on the indoor temperature and indoor humidity in the surroundings thereof. Thus, whether an air conditioner normally operates can be checked by measuring the indoor temperature and indoor humidity. On the other hand, the operation of an outdoor unit can be monitored by measuring the temperature of air supplied to the room (supply air temperature) and the temperature of air exhausted from the room (exhaust temperature) as the measurement data.

As stated above, the measurement data can include the feature data. Since the amount of the measurement data generally becomes huge, the feature data is provided in order to invite attention to characteristic values and specific measurement time in the measurement data. Providing the feature data makes it easy to grasp the operational status of the facilities and temporal changes in the measurement data.

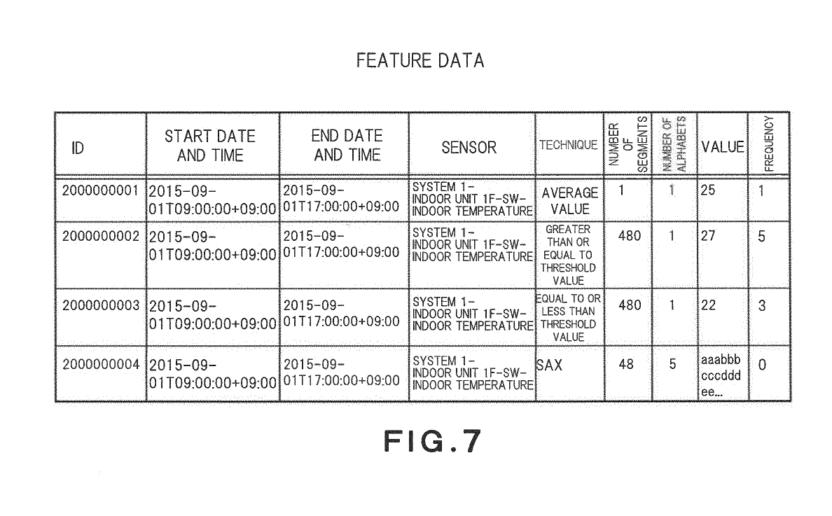

FIG. 7 is a diagram showing an example of a data structure of the feature data. The feature data of FIG. 7 is CSV format data obtained by relating the ID of a specific sensor 4, the start date and time of measurement, the end date and time of measurement, information about the installation location and measurement target of the sensor 4, a measurement technique, the number of segments, the number of alphabets, a value, and frequency.

A statistic such as the average value in a certain measurement period and a result of comparison with a threshold value is specified as a feature data. Instead, a well-known approximation technique may be applied to specify approximation data converted into a character string. SAX (Symbolic Aggregate approXimation) method is known as one of approximation techniques. In the SAX method, first, target measurement period is divided by a specified number of segments to calculate the average value in each segment, and then time-series data is divided by a specified number of alphabets so that each area under normal distribution becomes even, and a character string (e.g. alphabets) is assigned to each divided section. Note that the concrete calculation method, data structure, and data format of the feature data should not be limited to the above. The measurement technique of FIG. 7 employs a statistic and SAX.

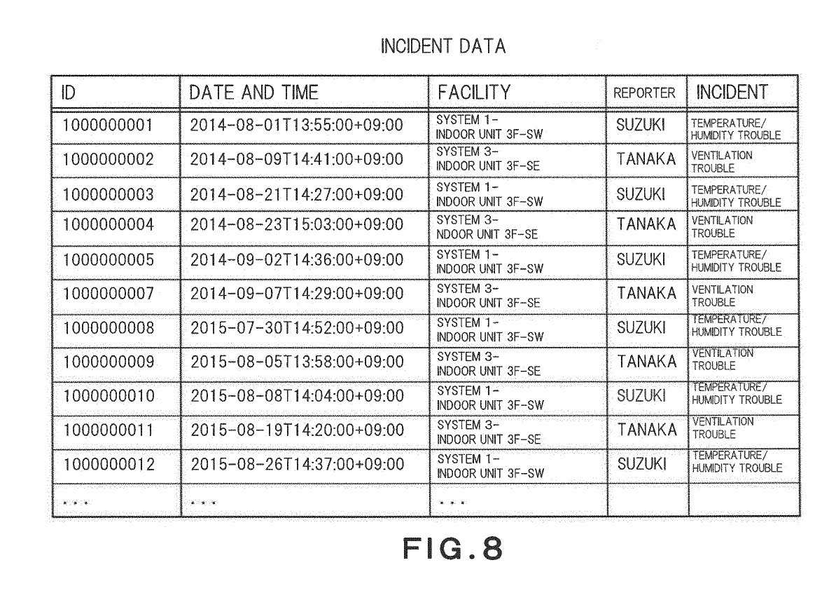

FIG. 8 is a diagram showing an example of a data structure of the incident data. The incident data of FIG. 8 is CSV format data obtained by relating the ID of each indoor or outdoor unit, the date and time of measurement, the name of each indoor or outdoor unit, the name of a maintenance worker, and the name of an incident. The incident is an event of concern in maintenance work, which is temperature/humidity trouble or ventilation trouble in the example of FIG. 8. The incident depends on each maintenance work. Note that it is not essential to provide the incident data.

Next, the knowledge graph data (i.e., ontology data) generated by the knowledge graph data generator 11 will be explained. The ontology means systematizing the relationship between concepts. Generally, RDF (Resource Description Framework) is utilized as an ontology model, but the model should not be limited thereto. RDF is a framework for describing resources on the Web, which is standardized by the W3C (World Wide Web Consortium). The RDF model expresses relational information about the resources by three elements, which are subject, predicate, and object. The subject shows a resource to be described. The predicate shows a relationship with the object or a feature of the subject. The object shows the value of the predicate or a thing related to the subject. The relational information about the resources expressed by these three elements is called triple. A set of triples is generally called an RDF graph. Each of the subject and predicate is expressed as a node, and the predicate is expressed as a link.

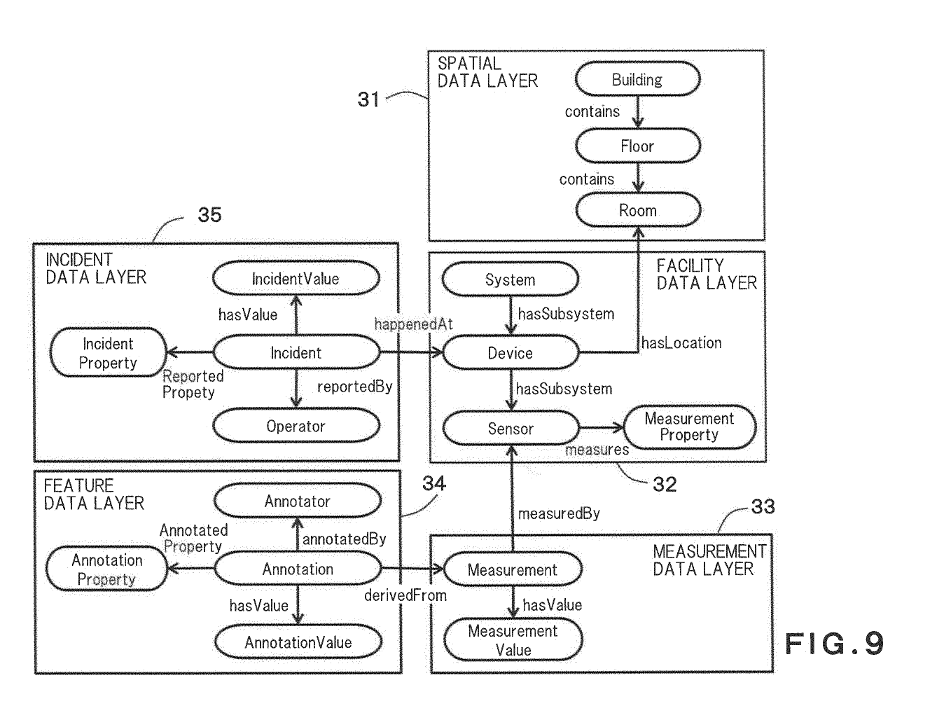

FIG. 9 is a diagram showing an example of the knowledge graph data (ontology data) in the present embodiment. Each node in FIG. 9 is also called a class. A kind of knowledge graph data concerning maintenance work is formed by connecting each node by a link. The knowledge graph data of FIG. 9 has a spatial data layer 31 concerning the spatial data, a facility data layer 32 concerning the facility data, a measurement data layer 33 concerning the measurement data, a feature data layer 34 concerning the feature data, and an incident data layer 35 concerning the incident data.

The spatial data layer 31 has a node “Building” concerning a building, a node “Floor” concerning a floor, and a node “Room” concerning a room, and these nodes are connected in this order by links “contains.”

The facility data layer 32 has a node “System” concerning all facilities, a node “Device” concerning each facility, a node “Sensor” concerning each sensor 4, and a node “MeasurementProperty” concerning measurement properties of each sensor 4. Further, the facility data layer 32 has a link “hasSubsystem” leading from the node “System” to the node “Device,” a link “hasLocation” leading from the node “Device” to the node “Room” of the spatial data layer 31, a link “hasSubsystem” leading from the node “Device” to the node “Sensor,” and a link “measures” leading from the node “Sensor” to the node “MeasurementProperty.”

The measurement data layer 33 has a node “Measurement” concerning measurement and a node “MeasurementValue” concerning a measured value. The measurement data layer 33 has a link “hasValue” leading from the node “Measurement” to the node “MeasurementValue” and a link “measuredBy” leading to the node “Sensor” of the facility data layer 32.

The feature data layer 34 has a node “Annotation” concerning a feature data, a node “Annotator” concerning a measurer of the feature data, a node “AnnotationValue” concerning the feature data, and a node “AnnotationProperty” concerning measurement properties of the feature data. Further, the feature data has a link “hasValue” leading from the node “Annotation” to the node “AnnotationValue,” a link “annotatedBy” leading from the node “Annotation” to the node “Annotator,” a link “annotatedProperty” leading from the node “Annotation” to the node “AnnotationProperty,” and a link “derivedFrom” leading from the node “Annotation” to the node “Measurement” of the measurement data layer 33.

The incident data layer 35 has a node “Incident” concerning an incident, a node “IncidentValue” concerning the incident data, a node “Operator” concerning a maintenance worker of the incident, and a node “IncidentProperty” concerning incident properties. Further, the incident data layer 35 has a link “hasValue” leading from the node “Incident” to the node “IncidentValue,” a link “reportedBy” leading from the node “Incident” to the node “Operator,” a link “reportedProperty” leading from the node “Incident” to the node “IncidentProperty,” and a link “happenedAt” leading from the node “Incident” to the node “Device” of the facility data layer 32. Note that the concrete system, data structure, and data format of the knowledge graph data should not be limited to the above.

The knowledge graph data generator 11 of FIG. 1 generates the knowledge graph data of FIG. 9 referring to the spatial data of FIG. 3, the facility data of FIG. 5, the measurement data of FIG. 6, the feature data of FIG. 7, and the incident data of FIG. 8.

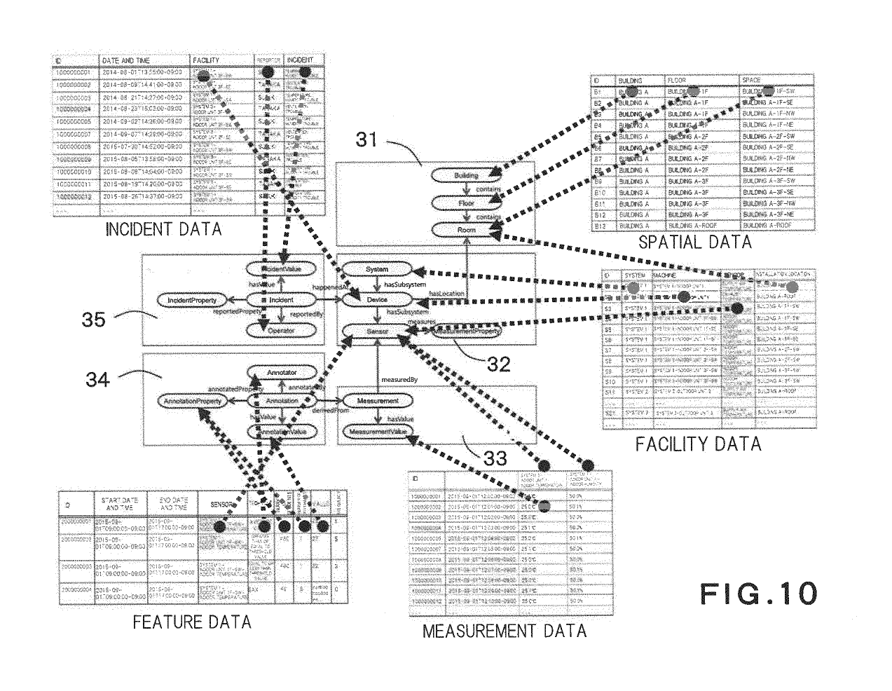

FIG. 10 is a diagram showing with arrows how to generate the knowledge graph data referring to the spatial data, facility data, measurement data, feature data, and incident data. In this way, the knowledge graph data is generated using the spatial data, facility data, measurement data, feature data, and incident data. This means that the knowledge graph data is obtained by relating the facility data, measurement data, feature data, and incident data in accordance with ontology transformation rules.

Note that, in the present embodiment, at least one of the feature data and incident data may be omitted from the knowledge graph data. That is, the knowledge graph data in the present embodiment is data obtained by relating at least the spatial data, facility data, and measurement data in accordance with ontology transformation rules.

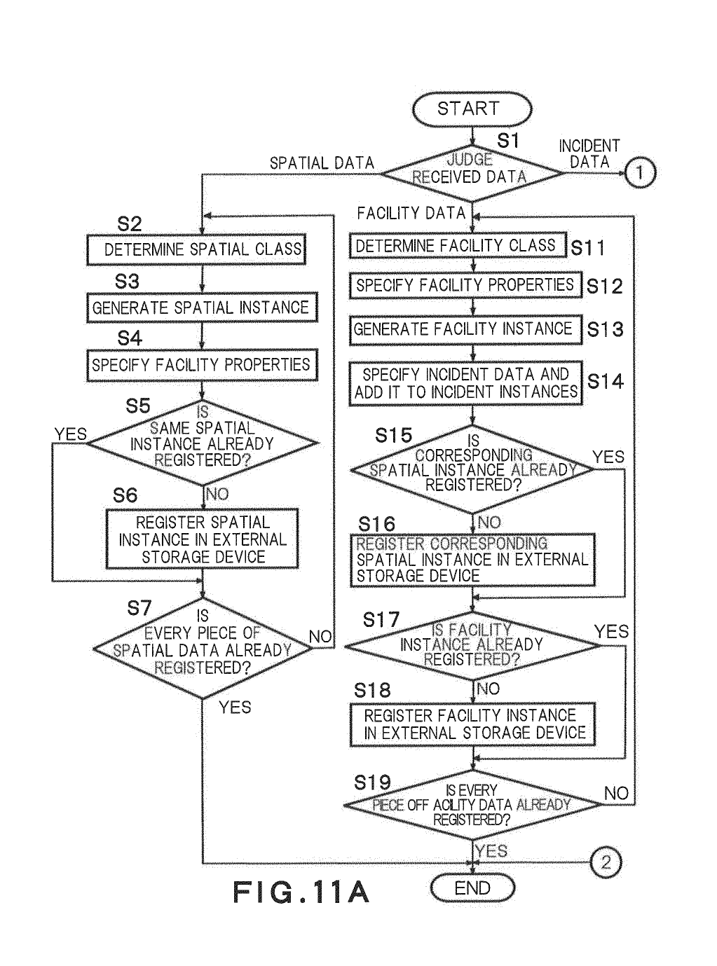

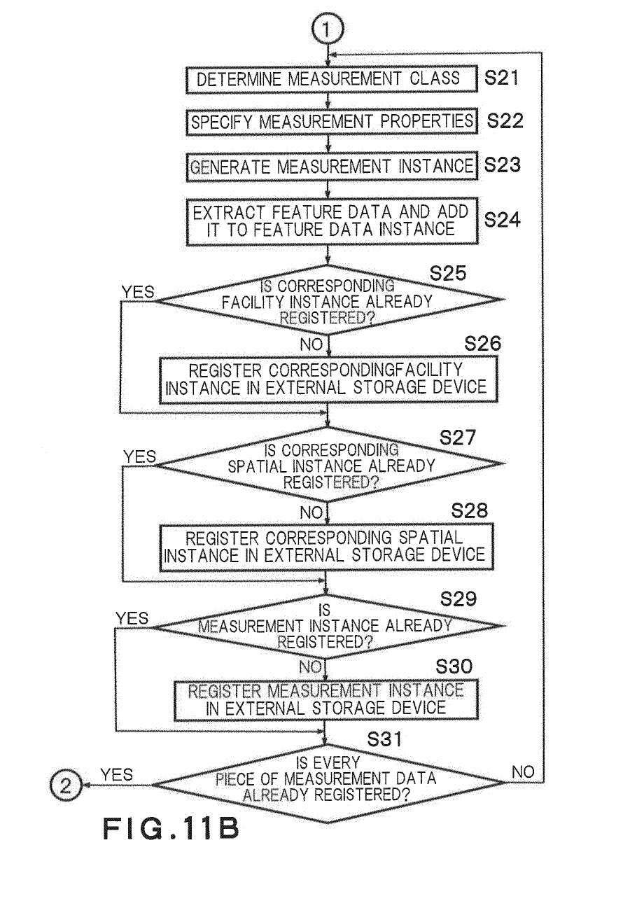

Each of FIGS. 11A and 11B is a flow chart showing an example of an operating procedure of the knowledge graph data generator 11. The knowledge graph data generator 11 generates the knowledge graph data (ontology data) by performing the process of FIGS. 11A and 11B based on the data received from the manager terminal 6 or sensor 4 through the network 7.

First, it is judged whether the received data is the spatial data facility data or measurement data (Step S1). In the case of spatial data, the process of Steps S2 to S7 is performed. In the case of facility data, the process of Steps S11 to S19 is performed. In the case of measurement data, the process of Steps S31 to S41 is performed. Note that when the received data includes the incident data, the process for the facility data is performed. Further, when the received data includes the feature data, the process for the measurement data is performed.

In the example shown in the flow charts of FIGS. 11A and 11B, the facility data includes the incident data, but the incident data may be treated separately from the facility data. In this case, at Step S1, it is judged whether the received data is the spatial data, facility data, measurement data, or incident data. When the received data is the incident data, a process for the incident data (not shown in FIGS. 11A and 11B) is performed to register an incident class in the external storage device. In FIG. 11A, the incident class is registered in the external storage device in the process for the facility data, as mentioned later.

In the example to be explained below, the spatial data utilizes IFC, which is widely employed as an architectural CAD data format, and the facility data utilizes COBie,

When the received data is the spatial data, a spatial class corresponding to the spatial data is determined first (Step S2), and then facility properties related to the spatial class are specified (Step S3), and a spatial instance corresponding to the spatial data is generated (Step S4). Here, the spatial instance means each piece of data included in the spatial data.

Next, it is judged whether the same spatial instance is already registered in the knowledge graph data (Step S5), and if already registered, registration is omitted to avoid duplication. If not already registered, a new spatial instance is registered in the knowledge graph data (Step S6).

Next, it is judged whether every piece of received spatial data is already registered in the knowledge graph data (Step S7), and if there is a piece of spatial data which is not registered yet, the process of Step S2 and steps subsequent thereto is repeated. When every piece of received spatial data is completely registered in the knowledge graph data, the process of registering the spatial data ends.

When the received data is judged to be the facility data at Step S1, a facility class corresponding to the facility data is determined (Step S11), and then facility properties related to the facility class are specified (Step S12), and a facility instance corresponding to the facility data is generated (Step S13), Next, the incident data corresponding to the facility data is specified, and added to incident instances (Step S14).

Next, it is judged whether a corresponding spatial instance is already registered in the knowledge graph data (Step S15), and if not registered yet, the corresponding spatial instance is generated and registered in the knowledge graph data (Step S16).

When it is judged that the corresponding spatial instance is already registered at Step S15 or when the registration process of Step S16 ends, it is judged whether the facility instance generated at Step S13 is already registered in the knowledge graph data (Step S17). If not registered yet, it is registered in the knowledge graph data (Step S18).

When it is judged that the facility instance is already registered at Step S17 or when the process of Step S18 ends, it is judged whether every piece of received facility data is completely registered in the knowledge graph data (Step S19), and if there is a piece of facility data which is not registered yet, the process of Step S11 and steps subsequent thereto is repeated. When every piece of received facility data is completely registered in the knowledge graph data, the process of registering the facility data ends.

When the received data is judged to be the measurement data at Step S1, a measurement class corresponding to the measurement data is specified as shown in FIG. 11B (Step S21). Here, the measurement data is CSV format data obtained by relating date and time, measured value, and unit. The measurement data is generated as a measurement instance of ssn:ObservationValue, and the date and time, measured value, and unit are stored as properties time, numericValue, and unit, respectively (Step S22, S23).

Next, a feature data is extracted from the measurement data (Step S24). As the feature data, outliers, upper and lower limit values, and an average value within a predetermined period are calculated, Instead, temporal changes may be symbolized by using an approximation technique called SAX for example.

Next, it is judged whether a corresponding facility instance is already registered in the knowledge graph data (Step S25), and if not registered yet, the corresponding facility instance is generated and registered in the knowledge graph data (Step S26). When it is judged that the corresponding facility instance is already registered at Step S25 or when the process of Step S26 ends, it is judged whether a corresponding spatial instance is already registered in the knowledge graph data (Step S27), and if not registered yet, it is registered in the knowledge graph data (Step S28). When it is judged that the corresponding spatial instance is already registered at Step S27 or when the process of Step S28 ends, it is judged whether a measurement instance is already registered in the knowledge graph data (Step S29), and if not registered yet, it is registered in the knowledge graph data (Step S30).

Next, it is judged whether every piece of received measurement data is completely registered in the knowledge graph data (Step S31), and if there is a piece of measurement data which is not registered yet, the process of Step S21 and steps subsequent thereto is repeated. When every piece of measurement data is completely registered, the process for the measurement data ends.

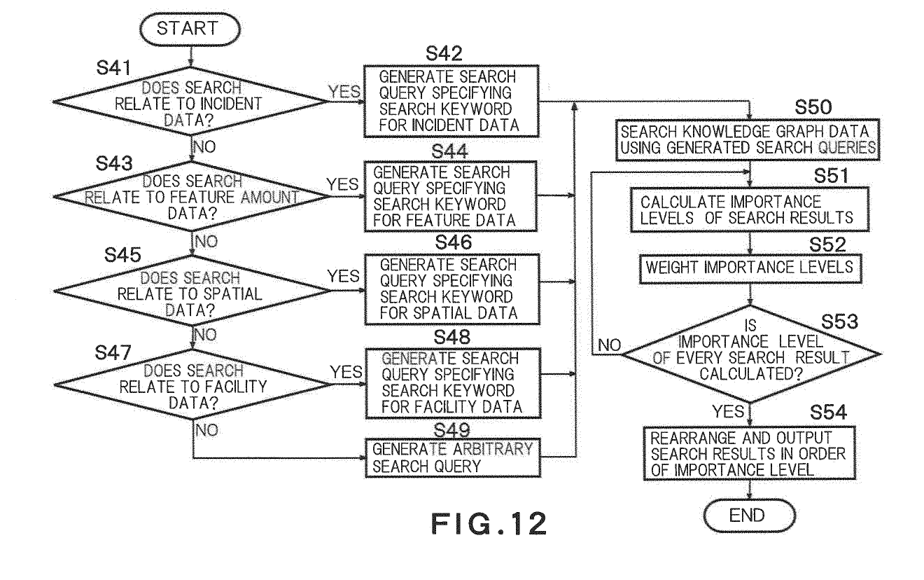

FIG. 12 is a flow chart showing an example of an operating procedure of the data search unit 13. The data search unit 13 receives a search request from the client terminal 5 through the network 7. The search request may be only a search keyword or may be a combination of a specified search target and a search keyword. When the search request is a combination of a specified search target and a search keyword, the search target is set by specifying at least one of a specific incident, a specific sensor 4, a specific space, and a specific facility. When no search target is specified and only a search keyword is given, search is performed on all available search targets.

The data search unit 13 judges whether the search keyword relates to a search on the incident data (Step S41). If the search is on the incident data, a search query is generated specifying the search keyword for the incident data (Step S42).

The search query is generated by using such a search language as SPARQL (SPARQL Protocol and RDF Query Language). SPARQL is a language which is standardized by the W3C to describe search queries for an RDF graph, and has a syntax similar to SQL. By giving a search condition using a combination of patterns concerning the triple of subject, predicate, and object constituting the RDF graph, subgraphs matching with such a pattern are acquired.

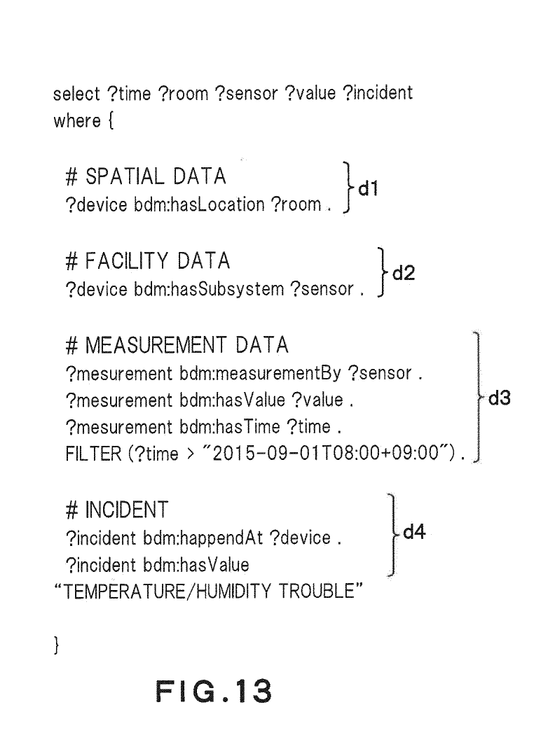

FIG. 13 is a diagram showing an example of a search query specifying a search keyword for the incident data. The search query of FIG. 13 includes a description d1 concerning the spatial data, a description d2 concerning the facility data, a description d3 concerning the measurement data, and a description d4 concerning the incident data. The description d4 describes a temperature/humidity trouble of the sensor 4 as an incident.

If the search keyword is judged not to relate to the incident data at Step S41 in FIG. 12, it is judged whether the search relates to the feature data in the measurement data (Step S43). If the search is judged to relate to the feature data in the measurement data, a search query is generated specifying the search keyword for the feature data in the measurement data (Step S44).

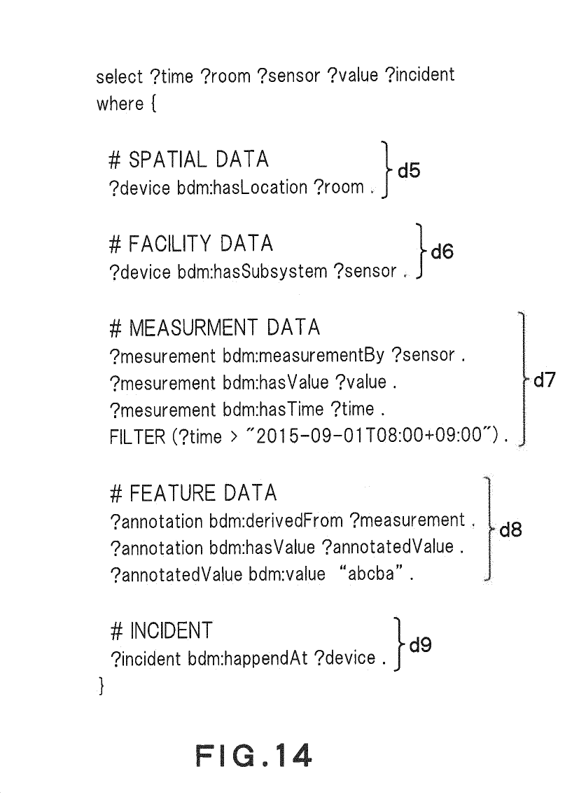

FIG. 14 is a diagram showing an example of a search query specifying a search keyword for the feature data in the measurement data. The search query of FIG. 14 includes a description d5 concerning the spatial data, a description d6 concerning the facility data, a description d7 concerning the measurement data, a description d8 concerning the feature data, and a description d9 concerning the incident data. The description d7 describes searching for a sensor 4 having a feature data of “abcba”.

If the search keyword is judged not to relate to the feature data in the measurement data at Step S43 in FIG. 12, it is judged whether the search relates to the spatial data (Step S45). If the search is judged to relate to the spatial data, a search query is generated specifying the search keyword for the spatial data (Step S46).

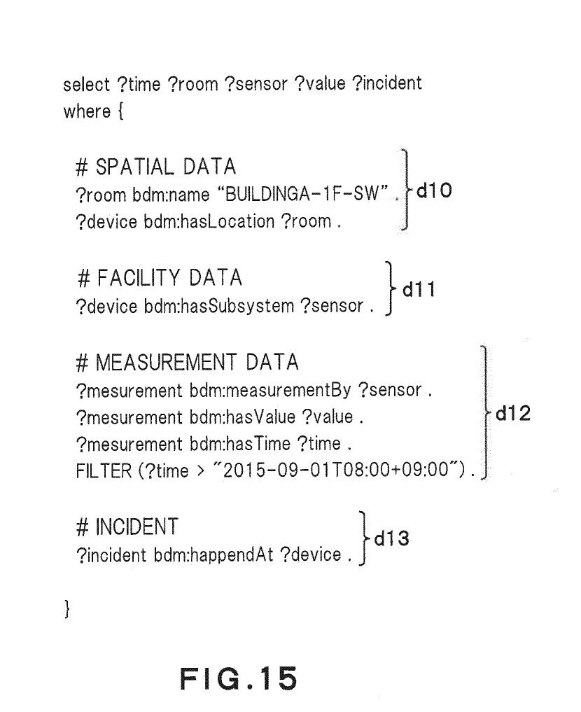

FIG. 15 is a diagram showing an example of a search query specifying a search keyword for the spatial data. The search query of FIG. 15 includes a description d10 concerning the spatial data, a description d11 concerning the facility data, a description d12 concerning the measurement data, and a description d13 concerning the incident data. The description d10 describes specifying “building A-1F-SW” as a room. Further, the description d11 describes acquiring data from 8:00 to 9:00 on Aug. 1, 2015. The search result of the search query of FIG. 15 is outputted after relating the facility installation location, sensor 4, date and time of measurement, measured value, unit, and incident specified by the search query.

If the search keyword is judged not to relate to the spatial data at Step S45 in FIG. 12, it is judged whether the search relates to the facility data (Step S47). If the search is judged to relate to the facility data, a search query is generated specifying the search keyword for the facility data (Step S48).

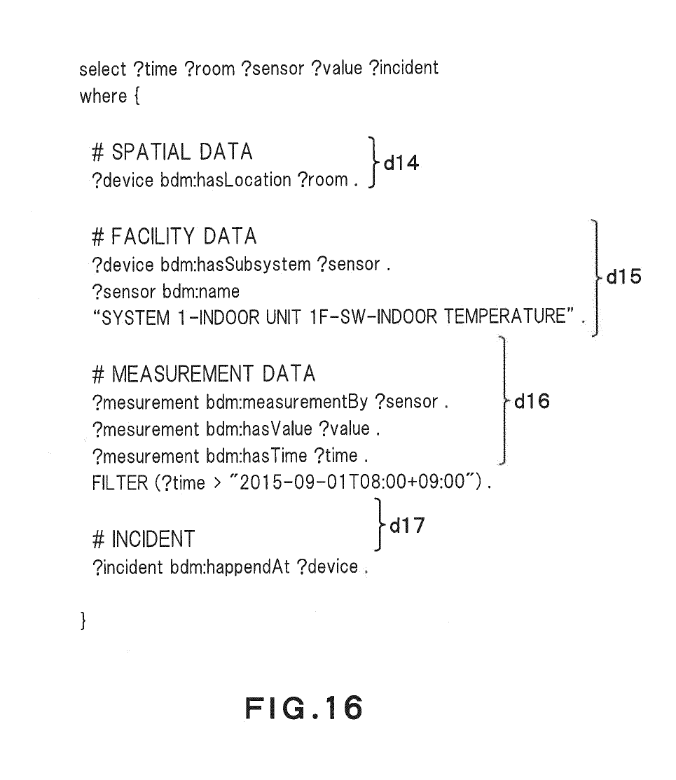

FIG. 16 is a diagram showing an example of a search query specifying a search keyword for the facility data. The search query of FIG. 16 includes a description d14 concerning the spatial data, a description d15 concerning the facility data, a description d16 concerning the measurement data, and a description d17 concerning the incident data. The description d15 describes specifying “system 1-indoor unit 1-SW-indoor temperature” as a sensor 4 for measurement.

If the search keyword is judged not to relate to the facility data at Step S47 in FIG. 12, an arbitrary search query is generated (Step S49). For example, the search query to be generated acquires the data searched by the search query at any one of Steps S42, S44, S46, and S48 as search results. That is, the search query to be generated may use the logical sum of the search queries at Steps S42, S44, S46, and S48 as a condition.

Next, the knowledge graph data is searched using the search queries generated at Steps S42, S44, S46, S48, and S49 (Step S50). Next, importance levels of the search results are calculated referring to the evaluation rules (Step S51). Then, the importance levels are weighted referring to history data (Step S52). For example, the importance level corresponding to data having a high appearance frequency is given a large weight coefficient. Next, it is judged whether the importance level of every search result is calculated (Step S53). If there is an importance level which is not calculated yet, the process of Step S51 and steps subsequent thereto is repeated. When it is judged that the importance level of every search result is completely calculated at Step S53, the search results are rearranged and outputted in descending order of importance level (Step S54).

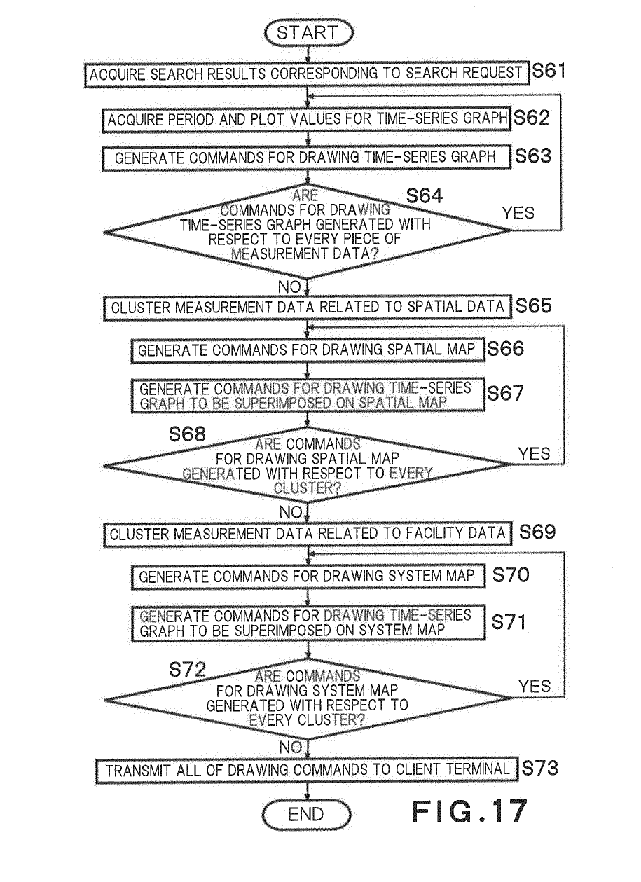

FIG. 17 is a flow chart showing an example of an operating procedure of the search result output unit 14. The search result output unit 14 acquires, from the data search unit 13, search results corresponding to the search request transmitted by the client terminal 5 (Step S61). The search results are generated as ontology data corresponding to the search keyword. The ontology data of the search results is data obtained by relating four types of data including the spatial data, facility data, measurement data, and incident data, for example. The number of data pieces related in the ontology data of the search results differs depending on the search query to be given.

The search result output unit 14 can generate a time-series graph, a spatial map, and a system map referring to the ontology data of the search results. FIG. 17 includes a process of generating a time-series graph (Steps S62 to S64), a process of generating a spatial map (Steps S65 to S68), and a process of generating a system map (Steps S69 to S72). The order of these generation processes may be arbitrarily changed. The time-series graph, spatial map, and system map are drawn utilizing a graph drawing library such as R language and JavaScript language.

When generating a time-series graph, the period and plot values for generating the time-series graph are determined referring to the feature data in the measurement data included in the ontology data of the search results acquired at Step S61 (Step S62). Next, commands for drawing the time-series graph are generated referring to the graph generation rules (Step S63). Next, it is judged whether the commands for drawing the time-series graph are generated with respect to every piece of measurement data (Step S64). If there is a piece of measurement data for which the drawing commands are not generated yet, the process of Step S62 and steps subsequent thereto is repeated.

If it is judged that the commands for drawing the time-series graph are completely generated at Step S64, a spatial map is generated. First, in view of the relationship with the spatial data, the measurement data is clustered (Step S65). Next, commands for drawing the spatial map are generated referring to the graph generation rules (Step S66). Next, commands for drawing the time-series graph to be superimposed on the spatial map are generated (Step S67). Next, it is judged whether the commands for drawing the spatial map are generated with respect to every cluster (Step S68). If there is a cluster for which the drawing commands are not generated yet, the process of Step S66 and steps subsequent thereto is repeated.

If it is judged that the commands for drawing the spatial map are generated with respect to every cluster at Step S68, the measurement data is clustered in view of the relationship with the facility data (Step S69). Next, commands for drawing the system map are generated referring to the graph generation rules (Step S70). Next, commands for drawing the time-series graph to be superimposed on the system map are generated (Step S71). Next, it is judged whether the commands for drawing the system map are generated with respect to every cluster (Step S72). If there is a cluster for which the drawing commands are not generated yet, the process of Step S70 and steps subsequent thereto is repeated.

If it is judged that the commands for drawing the system map are generated with respect to every cluster at Step S72, all of the generated drawing commands are transmitted to the client terminal 5 (Step S73). Upon receiving all of the drawing commands, the client terminal 5 draws the time-series graph, spatial map, or system map in accordance with the instructions by the maintenance worker.

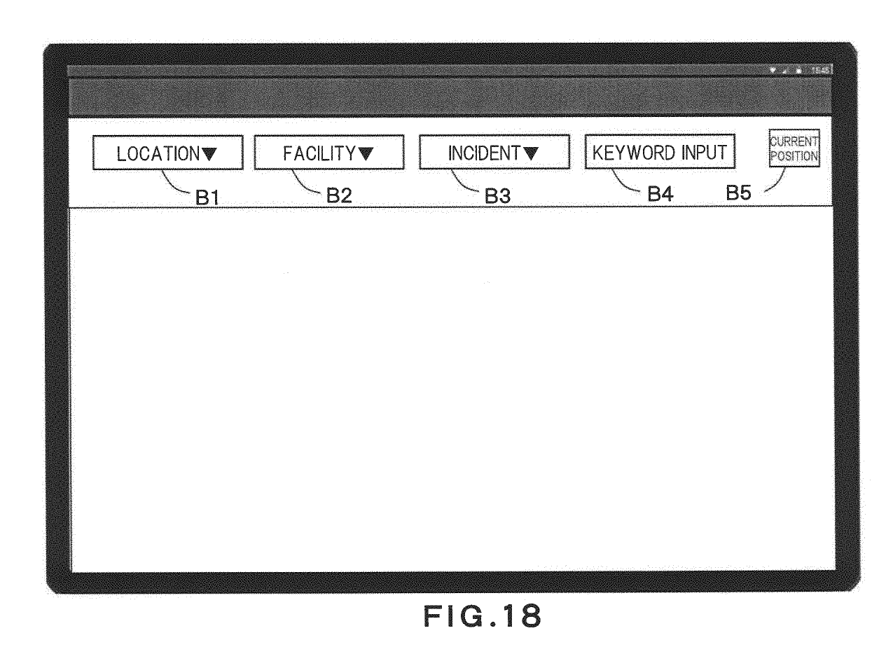

FIG. 18 is a diagram showing an example of the initial screen of the client terminal 5 making a search request. A button B1 for selecting a location, a button B2 for selecting a facility, a button B3 for selecting an incident, a button B4 for inputting a keyword, and a button B5 for acquiring a current position are provided on the upper side of the display screen. The maintenance worker can select or input the information he/she desires by arbitrarily operating these buttons B1 to B5. More concretely, as to the buttons B1 to B3, arbitrary information can be selected from an information list previously prepared, and as to the button B4, arbitrary information can be inputted. Further, when the button B5 is pushed, the current position is acquired by using a GPS sensor 4 (Global Positioning System) etc. or by accessing a server through the network 7. The information selected or inputted by the buttons B1 to B5 is incorporated into the character string of the search keyword and transmitted to the search information input unit 12 in the data management device 1 through the network 7.

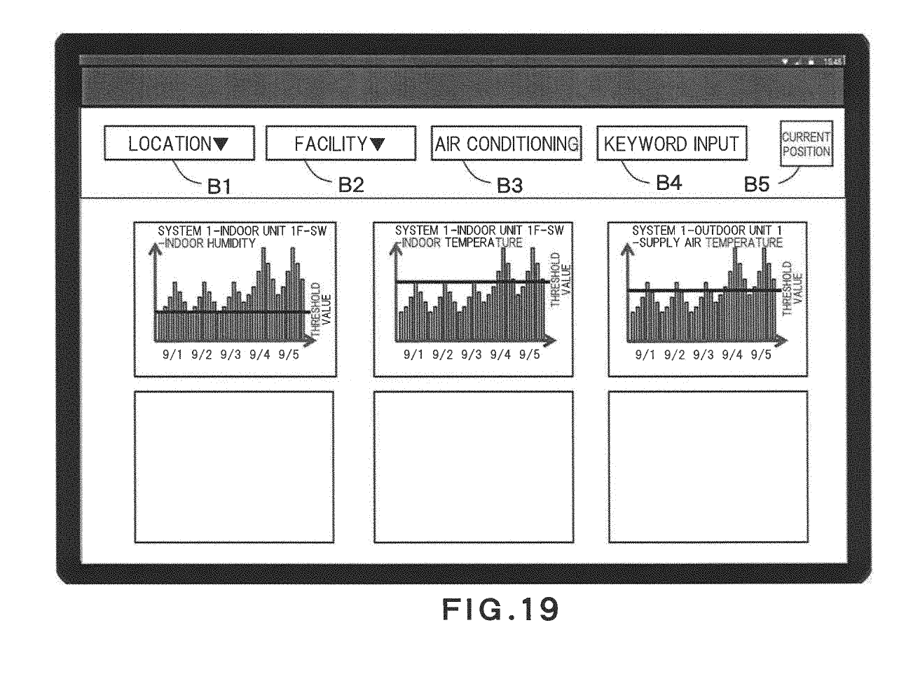

FIG. 19 is a diagram showing an example of time-series graphs on the display screen when selecting “air conditioning” by the button B3 for selecting an incident. FIG. 19 shows an example of displaying time-series graphs of the indoor humidity and indoor temperature concerning an indoor unit 1F-SW of system 1 at the current position and a time-series graph of supply air temperature. Displaying the time-series graphs of FIG. 19 requires determining the period and values to be plotted, referring to the feature data included in the measurement data.

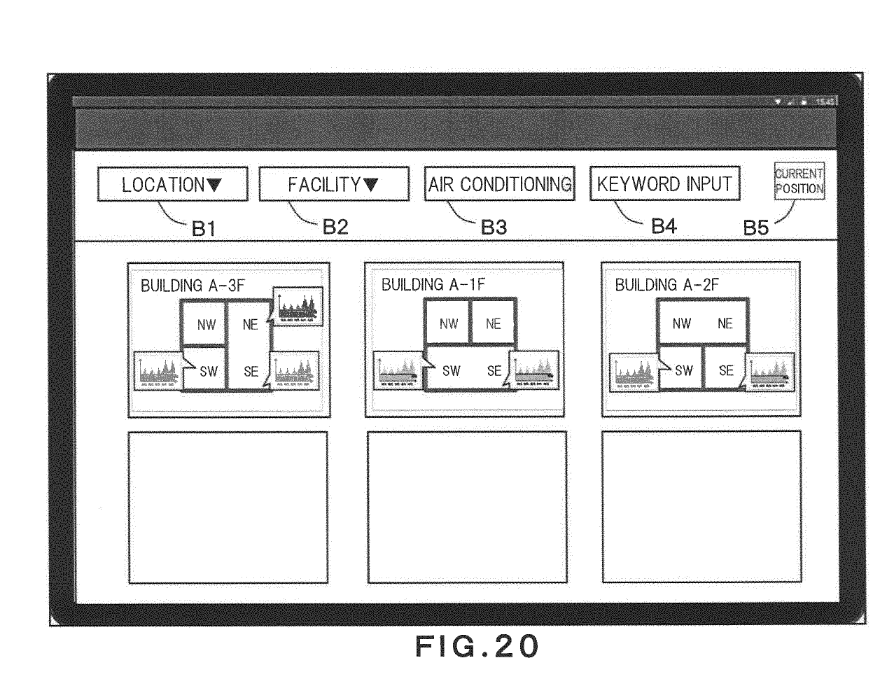

FIG. 20 is a diagram showing an example of spatial maps on the display screen, FIG. 20 shows an example of displaying the spatial maps of three floors synthesized with the time-series graphs of specific rooms on each floor.

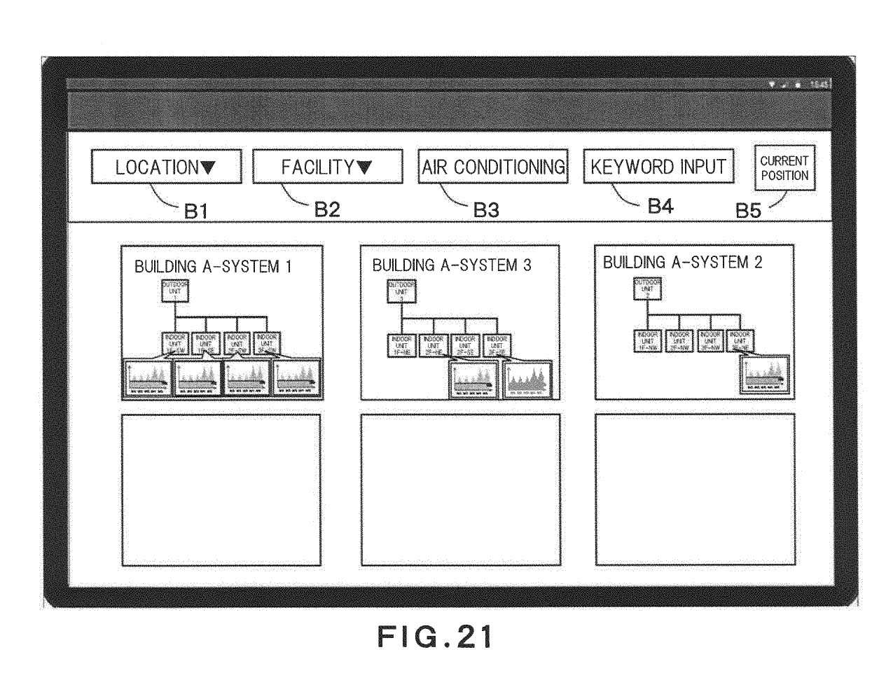

FIG. 21 is a diagram showing an example of system maps on the display screen. FIG. 21 shows an example of displaying the detailed facility configurations of three systems together with the time-series graphs of some of the sensors 4 in the each facility configuration.

The time-series graph of FIG. 19, the spatial map of FIG. 20, and the system map of FIG. 21 may be sequentially displayed on the display screen of the client terminal 5 in arbitrary order, or may be outputted in an arbitrary style previously selected by the maintenance worker using the client terminal 5. In the latter case, the information about the output format is incorporated into the search keyword and transmitted to the data management device 1, and the data management device 1 generates search result data matching with the selected output format.

In this way, in the present embodiment, the knowledge graph data is generated by relating the spatial data, facility data, and measurement data in accordance with ontology transformation rules, the knowledge graph data is searched based on a search keyword including a character string representing an incident, and the spatial data, facility data, and measurement data matching with the search keyword are related and outputted. This makes it possible for a maintenance worker performing maintenance work on maintenance facilities within a building to judge whether any abnormality is occurring in the maintenance facilities simply and quickly. In particular, the maintenance worker can inspect all of the maintenance facilities exhaustively and without omission by monitoring the spatial data, facility data, and measurement data related to one another. Further, when the measurement data includes the feature data, the search results can be outputted taking the feature data into account. Furthermore, since incident data concerning a specific incident can be outputted while being related to the spatial data, facility data, and measurement data, judgment of trouble and abnormality can be made quickly and correctly.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A data management device comprising:
a knowledge graph data generator to generate knowledge graph data by relating spatial data concerning space within a building in which a maintenance facility is installed, facility data concerning the maintenance facility, and measurement data obtained by measuring an operational status of the maintenance facility in accordance with ontology transformation rules;
a search information input unit to input a search keyword including a character string representing an incident;
a data search unit to search the knowledge graph data based on the search keyword; and
a search result output unit to relate and output the spatial data, facility data, and measurement data matching with the search keyword, based on search results obtained by the data search unit.

2. The data management device of claim 1,
wherein the measurement data includes feature data,
the search information input unit can input a character string representing an incident and a character string representing the feature data, and
when the character strings representing the incident and feature data are included in the search keyword, the search result output unit relates and outputs the spatial data, facility data, and measurement data matching with the search keyword.

3. The data management device of claim 1, wherein the search result output unit sorts the search results obtained by the data search unit in order of importance level based on an evaluation rule, and relates and outputs the spatial data, facility data, and measurement data matching with the search keyword in order of importance level.

4. The data management device of claim 1,
wherein the knowledge graph data generator generates the knowledge graph data by relating the spatial data, facility data, measurement data, and incident data in accordance with the ontology transformation rules, and
the search result output unit relates and outputs the spatial data, facility data, measurement data, and incident data matching with the search keyword.

5. The data management device of claim 1,
wherein the search information input unit inputs an output format in the search result output unit, and
the search result output unit outputs the search results obtained by the data search unit in accordance with the output format inputted by the search information input unit.

6. The data management device of claim 1,
wherein the output format which can be inputted by the search information input unit includes at least one of a time-series graph, a spatial map, and a system map, and
the search result output unit generates and outputs at least one of the time-series graph, spatial map, and system map in accordance with the output format inputted by the search information input unit, based on the spatial data, facility data, and measurement data matching with the search keyword.

7. The data management device of claim 6, wherein when the output format is the spatial map, the search result output unit sorts the measurement data into a plurality of groups based on the spatial data, generates the spatial map including the spatial data concerned with respect to each group referring to a graph generation rule, and superimposes, on the generated spatial map, the time-series graph including the measurement data belonging to a same group.

8. The data management device of claim 6, wherein when the output format is the system map, the search result output unit sorts the measurement data into a plurality of groups based on the facility data, generates the system map including the facility data concerned with respect to each group referring to a graph generation rule, and superimposes, on the generated system map, the time-series graph including the measurement data belonging to a same group.

9. The data management device of claim 1,
wherein the search information input unit inputs the search keyword including a character string specifying current position information, and
the search result output unit outputs data obtained by relating the spatial data, facility data, and measurement data concerning the current position information included in the search keyword.

10. A data management system comprising:
a mobile terminal; and
a data management device to communicate with the mobile terminal through a network,
wherein the mobile terminal transmits a search request to the data management device through the network, and receives search result data depending on the search request from the data management device, and
the data management device comprises:
a knowledge graph data generator to generate knowledge graph data by relating spatial data concerning space within a building in which a maintenance facility is installed, facility data concerning the maintenance facility, and measurement data obtained by measuring an operational status of the maintenance facility in accordance with ontology transformation rules;
a search information input unit to input a search keyword including a character string representing an incident, in accordance with the search condition from the mobile terminal;
a data search unit to search the knowledge graph data based on the search keyword; and
a search result output unit to output the search result data obtained by relating the spatial data, facility data, and measurement data matching with the search keyword, based on search results obtained by the data search unit.

11. A data management method comprising:
generating knowledge graph data by relating spatial data concerning space within a building in which a maintenance facility is installed, facility data concerning the maintenance facility, and measurement data obtained by measuring an operational status of the maintenance facility in accordance with ontology transformation rules;
inputting a search keyword including a character string representing an incident;
searching the knowledge graph data based on the search keyword; and
relating and outputting the spatial data, facility data, and measurement data matching with the search keyword, based on a search result on the knowledge graph data.

12. The data management method of claim 11,
wherein the measurement data includes feature data,
a character string representing an incident and a character string representing the feature data can be inputted as the search keyword, and
when the character strings representing the incident and feature data are included in the search keyword, the spatial data, facility data, and measurement data matching with the search keyword are related and outputted.

13. The data management method of claim 11, wherein the search results are sorted in order of importance level based on an evaluation rule, and the spatial data, facility data, and measurement data matching with the search keyword are related and outputted in order of importance level.

14. The data management method of claim 11, further comprising:
generating the knowledge graph data by relating the spatial data, facility data, measurement data, and incident data in accordance with the ontology transformation rules; and
relating and outputting the spatial data, facility data, measurement data, and incident data matching with the search keyword.

15. The data management method of claim 11,
wherein the search keyword includes an output format, and
the search results are outputted in accordance with the output format included in the search keyword.

16. The data management method of claim 11,
wherein the output format includes at least one of a time-series graph, a spatial map, and a system map, and
at least one of the time-series graph, spatial map, and system map is generated and outputted in accordance with an output format included in the search keyword, based on the spatial data, facility data, and measurement data matching with the search keyword.

17. The data management method of claim 16, wherein when the output format is the spatial map, the measurement data is sorted into a plurality of groups based on the spatial data, the spatial map including the spatial data concerned is generated with respect to each group referring to a graph generation rule, and the time-series graph including the measurement data belonging to the same group is superimposed on the generated spatial map.

18. The data management method of claim 16, wherein when the output format is the system map, the measurement data is sorted into a plurality of groups based on the facility data, the system map including the facility data concerned is generated with respect to each group referring to a graph generation rule, and the time-series graph including the measurement data belonging to the same group is superimposed on the generated system map.

19. The data management method of claim 11,
wherein the search keyword includes a character string specifying current position information, and
data obtained by relating the spatial data, facility data, and measurement data concerning the current position information included in the search keyword is outputted.

20. The data management method of claim 11,
wherein a mobile terminal transmits a search request to a data management device through a network, and receives search result data depending on the search request from the data management device, and
the data management device performs:
inputting the search keyword depending on the search request from the mobile terminal;
searching the knowledge graph data based on the search keyword; and
relating and outputting the spatial data, facility data, and measurement data matching with the search keyword, based on results of search on the knowledge graph data.
